(19) United States
(12) Patent Application Publication
(10) Pub. No.: US 2005/0009385 A1
(43) Pub. Date: Jan. 13, 2005

(54) Electrical connector having improved contacts

(76) Inventors: Iosif R. Korsunsky, Harrisburg, PA (US); Brian J. Gillespie, Harrisburg, PA (US); Tod M. Harlan, Mechanicsburg, PA (US)

Correspondence Address: WEI TE CHUNG;FOXCONN INTERNATIONAL, INC., 1650 MEMOREX DRIVE, SANTA CLARA, CA, 95050, US

(21) Appl. No.: 10/840,989

(22) Filed: May 7, 2004

Related U.S. Application Data
(63) Continuation-in-part of application No. 10/602,247, filed on Jun. 23, 2003, now Pat. No. 6,743,059.
(63) Continuation-in-part of application No. 10/604,353, filed on Jul. 14, 2003.

(51) Int. Cl. H01R 12/00

(52) U.S. Cl. 439/83

(57) ABSTRACT

An electrical connector includes a dielectric housing defining a number of passageways extending from a mating face to a mounting face thereof, and a number of stamped contacts disposed in the passageways. Each contact includes a stamped body portion and a mounting platform formed adjacent to a bottom edge of the body portion. The mounting platform extends beyond opposite surfaces of the body portion. A method of making such an electrical contact includes the steps of: stamping a sheet of metal to form a contact having a bottom edge; and forming a mounting platform adjacent the bottom edge and including first and second portions extending beyond opposite surfaces of the contact.

### CROSS-REFERENCE TO RELATED APPLICATIONS

The instant application is a continuation-in-part of the copending applications of U.S. patent application Ser. No. 10/602,247 filed on Jun. 23, 2003 and entitled “ELECTRICAL CONNECTOR WITH IMPROVED CONTACT RETENTION”, and Ser. No. 10/604,353 filed on Jul. 14, 2003 and entitled “MULTI-FUNCTION PICK-UP CAP OF THE ELECTRICAL CONNECTOR”, both of which are assigned to the same assignee with this application.

### BACKGROUND OF THE INVENTION

1. Field of the Invention

The present invention relates to electrical contacts for an electrical connector and a method for making the same, and particularly to electrical contacts mounted along a central line of a passageway with features along a bottom edge so as to configure a platform adapted to receive fusible elements thereon and a method for making the same.

2. Description of Related Art

To meet the requirement of reliable, high density electrical interconnections between two electronic devices, conductive elements in the form of solder balls are utilized to connect electrical contacts or connectors to a substrate, such as a printed circuit board (PCB). It is believed International Business Machine started to use ball grid array (BGA) technology on connectors, and it includes an array of solder balls attached to conductive contacts of a connector. One of the advantages of using a solder pre-form at the contact tails is that, during the reflow process, the surface tension of the molten solder pre-form provides a self-aligning characteristic which aligns the contact tails accurately with the conductive pads on the substrate. In addition, the dimensions of the pre-formed solder ball can be accurately controlled and therefore control the quantity of the solder. This results in a uniform and reliable solder joint between the contacts and the conductive traces on the printed circuit board.

U.S. Pat. No. 4,019,803 issued to Schell on Apr. 26, 1977 firstly discloses the use of solder pre-form (number 30 in FIG. 3) arranged on a contact tail portion (number 16) and connected to the conductive pad (number 46) of a substrate.

U.S. Pat. No. 4,592,137 issued to Tanaka et al. on Jun. 3, 1986 discloses a technique of attaching a solder ball to an end of a contact so as to electrically interconnect upper and lower conductive pads of a printed circuit board. U.S. Pat. No. 4,678,250 issued to Romine et al. on Jul. 7, 1987 discloses a solder pre-form (number 52 of FIG. 5) which is later reflow soldered to attach a pellet in a cavity of the contact tail (number 49) to a conductive pad (number 48) of a substrate. U.S. Pat. No. 4,767,344 issued to Noschese on Aug. 30, 1988 discloses the use of a solder pre-form on both the pin-type contact (FIGS. 3 and 4) and the straddle-mount contact (FIGS. 10 to 13). Again, during the reflow process, the contact tails are soldered to the pre-determined area of the printed circuit board (FIG. 10). U.S. Pat. No. 5,029,748 issued to Lauterbach et al. on Jul. 9, 1991 discloses again the use of solder pre-forms secured to the contact tail portion, typically disclosed in FIGS. 1 and 8. Lauterbach et al's device is very similar to Noschese's discussed above. From the description above, it can be appreciated that the use of solder pre-form or solder ball attached to the contact tail has been a long-known skill in the art ever since 1977 or even earlier.

The electrical connector industry appreciates the advantages of the solder pre-form. As such, more and more electrical connectors use the solder pre-form on the contact tails. Typically, U.S. Pat. No. 5,730,606 filed on Apr. 2, 1996 and later issued to Sinclair on Mar. 24, 1998 discloses the use of solder balls on contact tails of a connector. As clearly shown in FIGS. 9 and 10, the solder ball is accurately positioned in a well defined platform consisting of a U-shape stamped and formed contact. It can be easily seen from FIGS. 9 and 10 that the contact engaging arms extend along sidewall of the passageway. Those two contact arms define a mouth to receive a solder ball which is attached to a chip carrier package. Even earlier, U.S. Pat. No. 5,772,451 filed on Oct. 18, 1995 and later issued to Dozier, II et al. on Jun. 30, 1998 discloses a similar device to Sinclair, i.e. a flat end portion served as a platform to receive a solder ball thereon. Again, the solder balls or solder pre-forms are applied to the contact tails so as to attach the connector to the printed circuit board.

It should be noted that the prior arts disclosed share a common characteristic, in that the solder pre-form or solder ball is located outside the connector, i.e. the connector housing does not directly position the solder ball with respect to coplanarity of the solder pre-forms or solder balls. For example, all the solder pre-forms or solder balls are positioned and interface with contact tails only, and without any interrelationship with the housing. For example, Romine et al. discloses a cavity (number 50, column 3, lines 15-20) to partially receive the solder pre-form. Sinclair discloses the use of a well (number 82, column 7, lines 36-50). Dozier II, et al. discloses a cavity (FIG. 5A, number 502b) to self-align the solder ball. None of the prior arts use the housing to position the solder pre-forms or solder balls.

U.S. Pat. No. 6,024,584 issued to Lemke on Feb. 15, 2000 discloses again the use of solder pre-forms or solder balls on the contact tail, typically shown in FIGS. 12, 13, 24a in which the solder pre-form or solder ball is accurately supported and positioned by edges of a rectangular recess. The benefit of using a recess to position the solder ball is further emphasized in U.S. Pat. Nos. 6,164,983, 6,079,991 and 6,093,035 which are continuation-in-part of U.S. Pat. No. 6,024,584. The advantages of the recess have been recorded in detail in the specification from column 9, lines 66-67 to column 10, lines 1-26 of U.S. Pat. No. 6,093,035. As described in the specification, the functions of the recess are at least to receive a pre-determined solder paste and position the solder ball with edges of the recess. As a result, the coplanarity of the solder balls can be ensured. Even the contact tail in FIG. 24a discloses a solder pad, however, according to the specification, the solder pad is formed by bending the contact tail after the contact is inserted into the connector housing. There are disadvantages in manufacturing a connector with the disclosed technique and process.

There also exists a problem that since a large amount of the solder paste is placed in the recess, wicking of the solder from the recess up the contact is significantly serious when the connector is subject to a reflow process to fuse the solder ball onto the contact. Although the contact is provided with a coating and/or thermal break structure on a medial portion thereof, the solder wicking is still a problem since there exists a gap between the contact and the passageway, specially during the ball attachment phase in which the solder ball, solder paste are located above, while the contact is located downward.

As the demand of high density connectors became a trend of the connector industry, the number of contacts within a connector increased tremendously over the years. In high pin count applications, it is more difficult to use “insert-molding” to secure the contact within the housing, as disclosed in Romine et al. and Noschese, because the mold tooling will become too complicated for mass production. Sinclair and Dozier II, et al. disclose a method as follows: 1) forming the contact firstly; 2) inserting the contacts into the connector housing; and 3) attaching the solder pre-form to the contact tail. The contacts disclosed for this method have a complicated contour or configuration. This method is not practical for miniature, high density connectors. For example, Sinclair provides a “U-shaped” contact, while Dozier II, et al. provides a curve-shaped contact. These contacts are difficult to handle during the inserting process. Lemke discloses a preferable solution, however, the solder ball has to be positioned by the recess and the solder ball has to be bridged to the contact tail by solder paste because there is a gap between the solder ball and the contact tail. This creates another difficulty in designing the connector. Additionally, the solder pad is formed by bending the contact tail after the contact is inserted into the connector housing. This manufacturing process makes it difficult to control the solder ball coplanarity.

U.S. Pat. No. 6,016,254 issued to Pfaff on Jan. 18, 2000 discloses a chip tester with solder ball pre-attached thereon. Pfaff discloses two types of contacts, FIGS. 1 and 2, a pin-header, generally T-shaped, which is similar to Romine '250 patent, as discussed above, and FIGS. 3 and 4, an “L-shape” contact. It would be easier to attach a solder pre-form to the inverted “T-shaped” end which provides a “flat solder pad” for attaching the solder balls. Additionally, the “T” end completely resides within the solder ball. However, the contact shown in FIGS. 3 and 4 will be comparatively difficult for ball attachment since the tail portion 28 (FIG. 4) does not provide a “platform” for ball attachment.

Even the L-shape contact provides a platform to receive a solder ball thereon, the contact needs additional structures so as to be secured in a passageway. It is unlikely to arrange the contact retention portion along a central line of the passageway.

In some applications, it is preferable and possibly required that the contact be located in the middle of a passageway, such as what is disclosed in Romine '250 and Pfaff '254 (FIG. 1). However, those contacts belong to a “pin-header” which is made from conductive wire. Since the contact engaging portion is merely a “pin”, it would be impossible to interconnect or mate with another “pin-type contact”. Lemke '584, Dozier II '451 and Pfaff '254 (FIG. 4) disclose a stamped contact with an L-shaped tail so as to provide a solder pad for ball attachment. The stamped contact can be easily made by method known to the skill in the art. However, it would be difficult, and almost impossible, to place the contact in the middle of the passageway. FIG. 13 of Lemke '584 does disclose a stamped contact positioned within a middle of a passageway. However, Lemke does not suggest or teach how to provide a “flat-platform” for ball attachment. As a result, a “recess” defined in the exterior side of the housing has to be introduced to position the solder ball on the tip of the contact by means of solder paste filled in the recess.

U.S. Pat. No. 6,042,389 issued to Lemke et al. discloses a low profile connector similar to the '584 patent discussed above. Besides the relationship between the solder ball and the contact end which has been disclosed by FIG. 13 of the '584 patent, the '389 patent provides a recessed area in a first housing adjacent a first contact of a first connector so as to receive a distal end of a second contact of a second mating connector, see FIGS. 2 and 4 of the '389 patent.

Attention is drawn to FIG. 2 of the '389 patent, where it can be readily seen from the drawing that the first contact 28 is held by a pair of tapered retention projections 49 in the first housing. These projections support the contact only along a center line of the contact, providing insufficient resistance to rotation along the center line. As a result, during the mating of the first and second connectors, the first contact 28 tends to twist as pivoted about the tapered retention projections 49. If the first contact 28 is displaced from its original position, reliable connection will be lost since there is not enough normal force between those two contacts or there would be a stubbing of the mating contacts resulting from the twisted contact.

U.S. Pat. No. 6,241,535 issued to Lemke et al. discloses a device in which a contact inserted into a passage of a housing is positioned and secured by a solder ball fused to the contact tail, see FIG. 3. In addition, the solder ball and/or solder paste is even filled a void defined between the contact tail and walls of a recess in an exterior side of the housing. As emphasized in the '535 patent, the invention is characterized in that the contact is prevented from removal by the use of the solder ball. However, during handling or delivery of the device, it is possible that a contact might be damaged and require replacement. As mentioned, the contact is prevented from removal from the passage by the fused solder ball. Unless the solder ball is removed, it is impossible to remove the contact from the passage.

In addition, as clearly seen from FIG. 4, there is only a small slit between the passage and the recess for the contact to pass through. Even if most of the solder ball material is removed, there is still some solder residue remaining on the contact tail, which makes the contact to be difficult to remove. In a second scenario, the contact may be damaged during use, after the connector is reflowed to the printed circuit board. In this scenario, access to the solder ball is blocked by the printed circuit board. Therefore, it is not possible to remove the solder ball, and thus, not possible to remove the contact. None of the prior art connectors discussed above allow the removal of the contact together with the solder ball after the connector is mounted on a printed circuit board. For example, Lemke's solder is located in a recess on the bottom surface, it is impossible to remove the solder through a tiny slot (substantially equivalent to the thickness of the contact) out of the printed circuit board. If the damaged contact can not be replaced, the whole printed circuit board has to be throw away.

Hence, an improved electrical contact for receiving a solder ball is required to overcome the disadvantages of the related art.

### SUMMARY OF THE INVENTION

Accordingly, it is an object of the present invention to provide an electrical contact for a high density connector having an improved mounting platform for receiving a fusible element or a body of solder.

It is another object of the present invention to provide a method for making an electrical contact having an improved mounting platform for receiving a solder ball.

It is still another object of the present invention to provide an electrical connector with a contact positioned in a medial plane of a passageway thereof, the contact having a mounting platform adjacent a mounting surface of the connector for receiving a fusible element or a body of solder.

It is still another object of the present invention to provide an electrical connector assembly comprising two mating connectors, wherein each electrical contact of the connectors is positioned in a medial plane of a passageway of the connector and comprises a mounting platform for receiving a fusible element or a body of solder.

In order to achieve the objects set forth, an electrical connector in accordance with the present invention comprises a dielectric housing defining a plurality of passageways extending from a mating face to a mounting face thereof, and a plurality of stamped contacts disposed in the passageways. Each contact comprises an intermediate portion, a mating portion extending from the intermediate portion, a tail portion extending in a direction opposite to the mating portion from the intermediate portion, and a mounting platform formed adjacent to the bottom edge of the tail portion adapted to receive a solder pre-form. The mounting platform includes a first portion extending substantially perpendicular to the tail portion, and a second portion extending away from the first portion.

According to one aspect of the present invention, a method of making such an electrical contact comprises the steps of: stamping a sheet of metal to profile a carrier strip comprising a plurality of contacts each having a bottom edge; and forming a mounting platform adjacent the bottom edge.

According to another aspect of the present invention, the contact is substantially positioned in a central plane of the passageway of the housing. The mounting platform is located adjacent to a mounting face of the housing and is substantially symmetric with respect to the central plane of the passageway of the housing.

Still according to another aspect of the present invention, the mating portion includes a pair of cantilevered arms completely extending beyond the mating face of the housing.

It is still an object of the present invention to provide a connector, in which a contact can be removed from the passage in which it sits. In addition, right after the contact is removed, the solder mass attached to the printed circuit can be suitably removed. Other objects, advantages and novel features of the invention will become more apparent from the following detailed description when taken in conjunction with the accompanying drawings.

### BRIEF DESCRIPTION OF THE DRAWINGS

FIG. 1 is an exploded, perspective view of a connector assembly in accordance with the present invention, the connector assembly comprising a receptacle connector and a plug connector, but showing only one receptacle contact thereof and only one plug contact thereof each having a solder ball attached thereon for simplicity;

FIG. 2 is a perspective view of the receptacle connector with the receptacle contact retained therein;

FIG. 3 is a perspective view of the receptacle contact connecting with a carrier in accordance with a first embodiment of the present invention;

FIG. 4 is an assembled view of FIG. 1, with parts of the receptacle connector and the plug connector cut away to show the receptacle contact and the plug contact mated together;

FIG. 5 is an enlarged view of a circled area of FIG. 4;

FIG. 6 is a partially cross-section view of a receptacle connector with receptacle contacts retained therein according to an alternative embodiment of the present invention;

FIG. 7 is a plane view schematically showing the plug contact received in a passageway of a plug connector housing;

FIG. 8 is a perspective view of a plurality of plug contacts connecting with a carrier to form a carrier strip and a plurality of solder balls attached on the plug contacts according to a first embodiment of the present invention;

FIG. 9 is a partially cut away cross-sectional view of the plug connector showing the plug contacts received in the plug connector housing;

FIG. 10 is a perspective view of a unit of the carrier strip of FIG. 8, showing the plug contact formed with a projection thereof;

FIG. 11 is a perspective view of the unit of the carrier strip, showing the plug contact having a mounting platform formed from the projection;

FIG. 12 is a front planar view of the unit of the carrier strip shown in FIG. 1;

FIG. 13 is a side view showing the unit of the carrier strip of FIG. 11 with a solder ball attached to the plug contact thereof;

FIG. 14 is a schematic view showing the centerline A of the mounting platform offsetting from the centerline A1 of the thickness of the plug contact;

FIG. 15 is a schematic view showing the centerline B of the mounting platform offsetting from the centerline B1 of the width of the plug contact;

FIG. 16 is a perspective view of the unit of the carrier strip having a plug contact in accordance with a second embodiment of the present invention;

FIG. 17 is a front planar view of the unit of the carrier strip shown in FIG. 16;

FIG. 18 is a perspective view of a plug contact in accordance with a third embodiment of the present invention;

FIG. 19 is a perspective view of a plug contact in accordance with a fourth embodiment of the present invention;

FIG. 20 is a perspective of a plug contact in accordance with a fifth embodiment of the present invention;

FIG. 21 is an exploded view of the plug contact shown in FIG. 19;

FIG. 22 is a perspective of a receptacle contact in accordance with a second embodiment of the present invention; and

FIG. 23 is an exploded view of the receptacle contact shown in FIG. 22.

### DETAILED DESCRIPTION OF THE PREFERRED EMBODIMENT

Reference will now be made in detail to the preferred embodiment of the present invention.

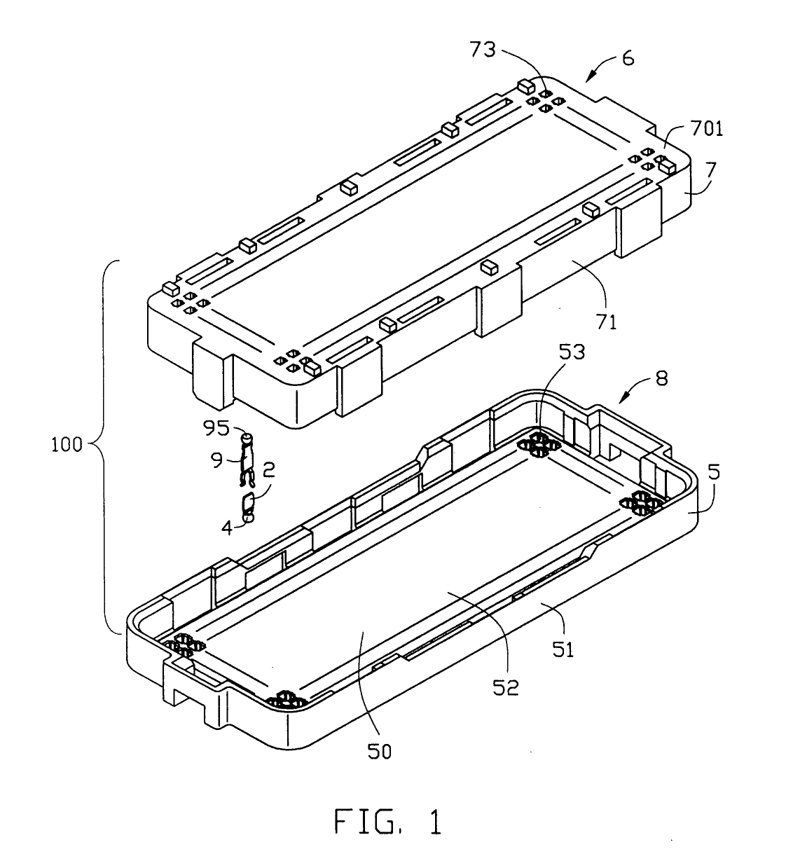

Referring to FIG. 1, a connector assembly 100 in accordance with the present invention comprises a receptacle connector 6 and a plug connector 8 adapted to mate with the receptacle connector 6.

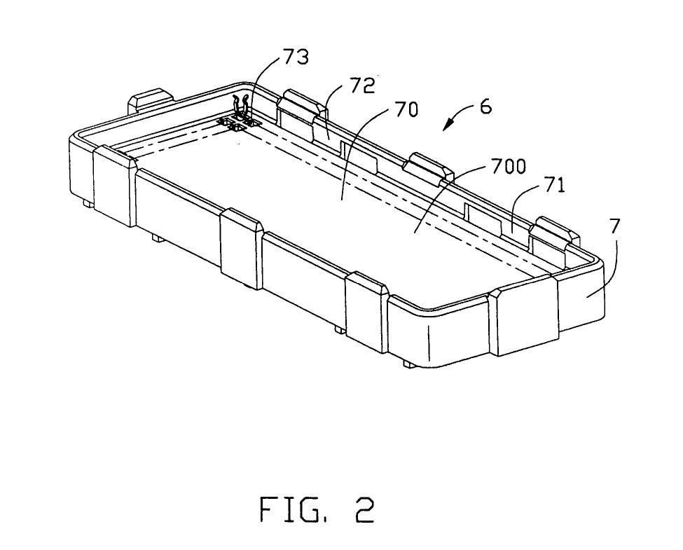

Referring to FIG. 2 in conjunction with FIG. 1, the receptacle connector 6 comprises a dielectric receptacle housing 7 having a base wall 70 and side walls 71 extending from peripheral edges of the base wall 70, together defining a cavity 72. The base wall 70 defines a mating face 700 adapted to face the plug connector 8 and a mounting face 701 opposite to the mating face 700 adapted to face a first circuit substrate (not shown). A plurality of rectangular passageways 73, which are arranged in multiple rows, extend from the mating face 700 to the mounting face 701 of the receptacle housing 7 for receiving a plurality of receptacle contacts 9. For simplicity, only a few passageways 73 and one receptacle contact 9 are shown.

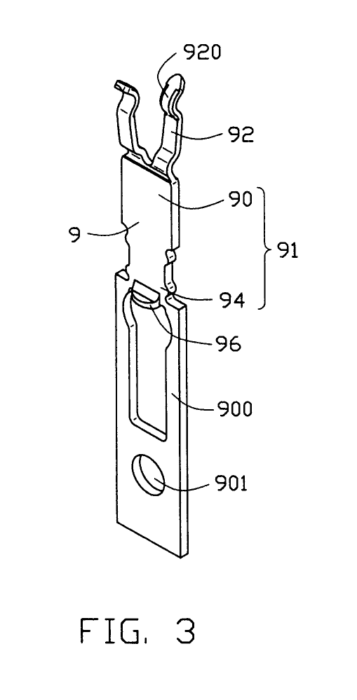

FIG. 3 illustrates a receptacle contact 9 stamped from a metal sheet and having a carrier 900 connected therewith. The carrier 900 defines a round hole 901 for engaging with a driving wheel (not shown) by which the carrier 900 can be moved in a continuous stamping process. The receptacle contact 9 includes a rectangular body portion 91, a pair of cantilevered arms 92 extending upwardly from a top of the body portion 91 and a mounting platform 96 formed adjacent a bottom of the body portion 91. The body portion 91 includes an intermediate portion 90 and a tail portion 94 extending from the intermediate portion 90 and connecting with the carrier 900. The mounting platform 96 is formed on the tail portion 94. Each cantilevered arm 92 is formed with a contact portion 920. As shown in FIG. 1, a solder ball 95 is attached to the mounting platform 96 for soldering the receptacle contact 9 to the first circuit substrate on which the receptacle connector 6 is mounted.

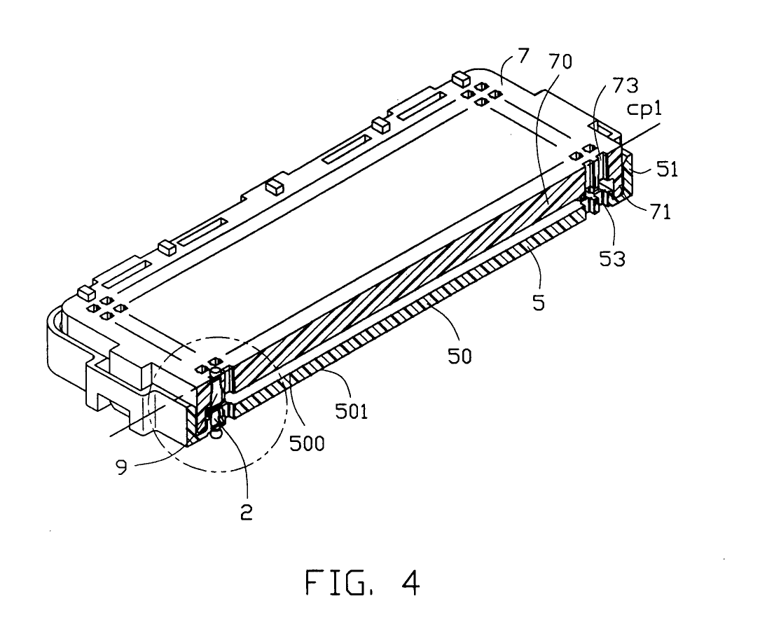

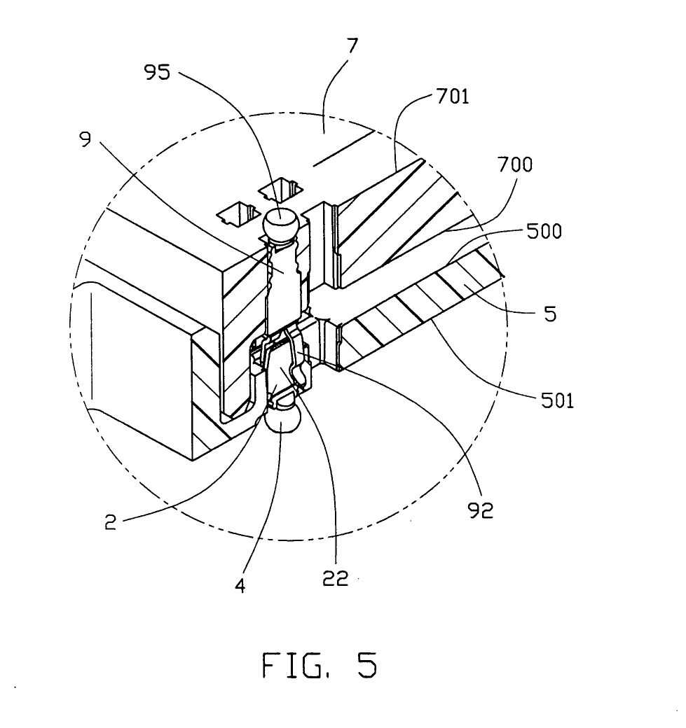

Referring to FIGS. 4 and 5, the receptacle contact 9 is retained in the rectangular passageway 73 of the receptacle housing 7. The intermediate portion 90 (shown in FIG. 3) of the receptacle contact 9 is substantially positioned in a central plane CP1 (FIG. 4) of the rectangular passageway 73. The pair of cantilevered arms 92 are completely exposed beyond the mating face 700 of the receptacle housing 7 and are accommodated in the cavity 72.

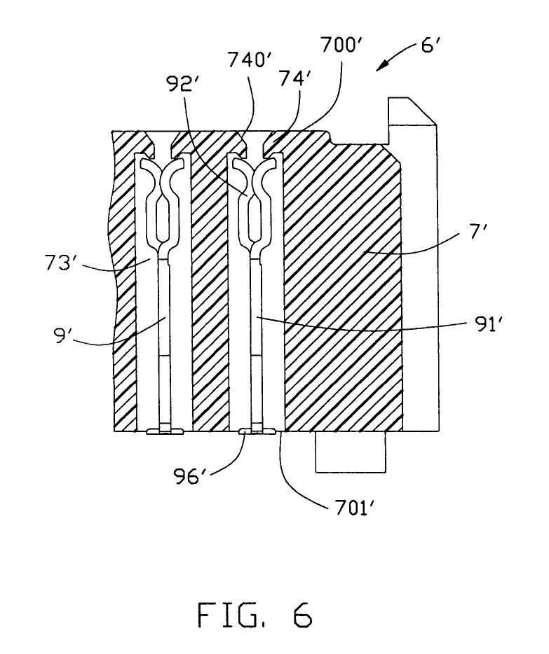

FIG. 6 shows a receptacle connector 6′ in accordance with an alternative embodiment of the present invention. The receptacle connector 6′ comprises a dielectric receptacle housing 7′ defining a mating face 700′ and a mounting face 701′ opposite the mating face 700′. A plurality of rectangular passageways 73′, which are arranged in multiple rows, extend from the mating face 700′ to the mounting face 701′ of the receptacle housing 7′ for receiving a plurality of receptacle contacts 9′. The housing 7′ is formed with a pair of projections 74′ extending toward each other from opposite inner faces of the passageway 73′ adjacent the mating face 700′. The pair of projections 74′ define a pair of opposite guiding faces 740′ adjacent the mating face 700′.

The receptacle contact 9′ is substantially identical to the receptacle contact 9 and comprises a rectangular body portion 91′, a pair of cantilevered arms 92′ extending upwardly from a top of the body portion 91′ and a mounting platform 96′ formed adjacent a bottom of the body portion 91′. The pair of cantilevered arms 92′ are not exposed beyond the mating face 700′ and are completely received in the rectangular passageway 73′ to prevent the cantilevered arms 92′ from being damaged during the delivery, handling, or use of the receptacle connector 6′, for example mating and separating a plug and receptacle connectors. Even the mounting and dismounting of the protection cap over the connectors, it causes damages. By this arrangement discussed above, free ends of the pair of cantilevered arms 92′ are respectively and protectively located below the projections 74′, thereby protecting the cantilevered arms 92′ from being damaged.

Referring to FIGS. 1 and 4, the plug connector 8 comprises a dielectric plug housing 5 having a base wall 50 and side walls 51 extending from peripheral edges of the base wall 50, together defining a cavity 52. The base wall 50 defines a mating face 500 adapted to face the receptacle connector 6 and a mounting face 501 opposite to the mating face 500 adapted to face a second circuit substrate (not shown). A plurality of rectangular passageways 53, which are arranged in multiple rows, extend from the mating face 500 to the mounting face 501 of the plug housing 5 for receiving a plurality of plug contacts 2. For simplicity, only a few passageways 53 and one plug contact 2 are shown in FIG. 1. The plug contact 2 will be described in detail hereinafter.

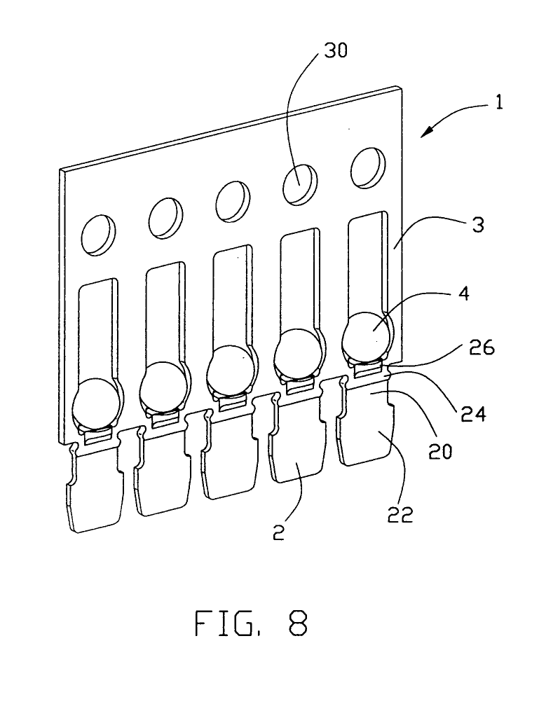

FIG. 8 shows a plurality of plug contacts 2 connecting with a carrier 3 to form a carrier strip 1. For simplicity, only a unit of the carrier strip 1 is shown in FIGS. 10-17. The carrier 3 defines a row of round holes 30 therein for engaging with a driving wheel (not shown), whereby the carrier 3 can be moved by the driving wheel in a continuous stamping process. A plurality of fusible elements, such as solder balls 4 are attached on the plug contacts 2.

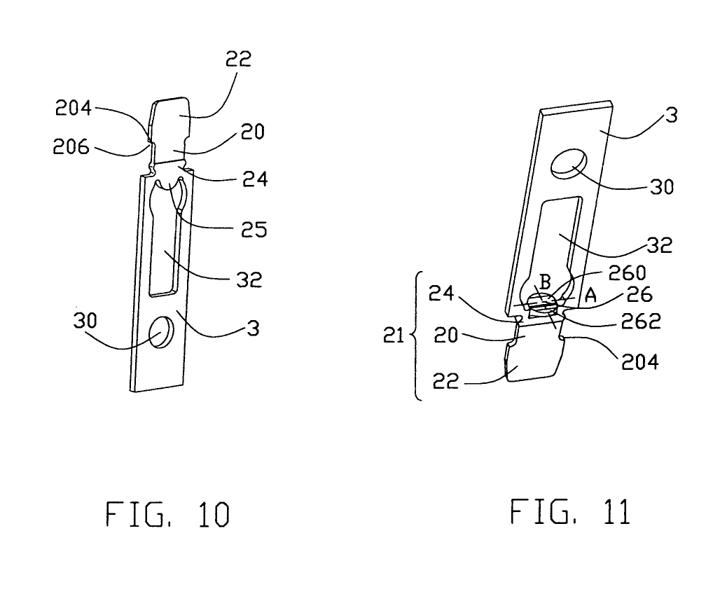

Referring to FIGS. 11 and 12, the plug contact 2 comprises a stamped rectangular body portion 21 and a mounting platform 26 formed on a bottom edge of the body portion 21. The stamped body portion 21 comprises an intermediate portion 20, a mating portion 22 extending from the intermediate portion 20 for engaging with the receptacle contact 9 and a tail portion 24 extending from the intermediate portion 20 and connecting with the carrier 3. The mating portion 22 has a larger width than the intermediate portion 20 thereby a shoulder 204 being formed on each side edge of the body portion 21 and a recess 206 being formed under the shoulder 204. It is understood that the mating portion 22 of the plug contact 2 may have a thinner width than the intermediate portion 20 while the intermediate portion 20 has a larger width than the tail portion 24 thereby forming a shoulder between the intermediate portion 20 and the tail portion 20 and forming a recess under the shoulder. The retention of the plug contact 2 in the plug housing 5 will be described in detail below.

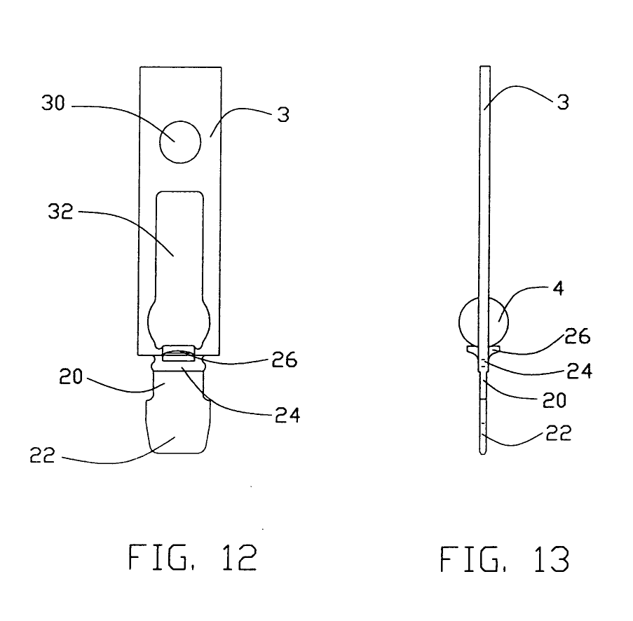

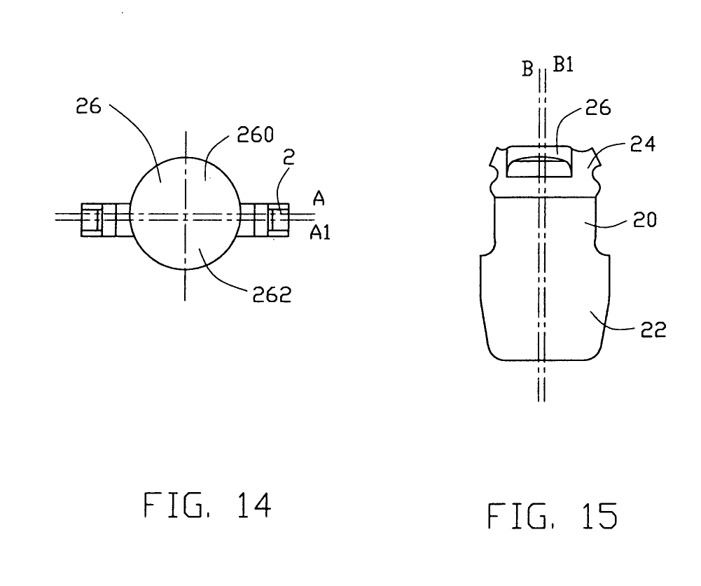

FIG. 10 shows the unit of the carrier strip 1 with a semi-manufactured contact 2. The carrier 3 defines an elongated slot 32 therein. The tail portion 24 has a projection 25 at a bottom edge thereof and extending into the slot 32. The mounting platform 26 is created from the projection 25 by forming the projection 25. The projection 25 is split with a tool, then flattened to form a mounting platform 26 as shown in FIG. 10. The mounting platform 26 extends beyond opposite surfaces of the tail portion 24 and is substantially symmetric with respect to its centerlines A and B in two directions (shown in FIG. 11). The mounting platform 26 is divided into first and second portions 260, 262 by the centerline A1 (FIG. 14) of the thickness of the tail portion 24. The first and the second portions 260, 262 extend laterally away from the bottom edge of the tail portion 24 in opposite directions and substantially perpendicular to the body portion 21. In a preferred embodiment, the mounting platform 26 is substantially symmetric with respect to the centerline A1 of the thickness of the tail portion 24 and the centerline B1 (FIG. 15) of the width of the tail portion 24. In alternative embodiments, as clearly shown in FIGS. 13 and 14, the first portion 260 is larger than the second portion 262 to allow the centerline A of the mounting platform 26 to offset from the centerline A1 of the thickness of the tail portion 24. The centerline B of the mounting platform 26 may also offset from the centerline B1 of the width of the tail portion 24.

Referring to FIG. 13, the solder ball 4 is attached on the mounting platform 26 and is symmetric with respect to the centerline of the thickness of the tail portion 24. The individual plug contacts 2 are formed by removing the carrier 3 from the carrier strip 1.

It is noted that the mounting platform 96 of the receptacle contact 9 is formed by the same manner as the mounting platform 26 of the plug contact 2 described above.

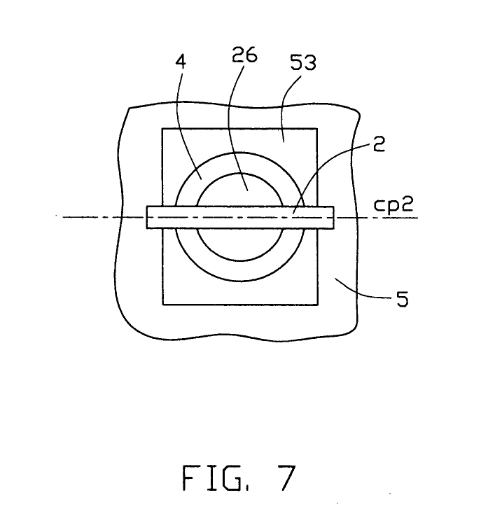

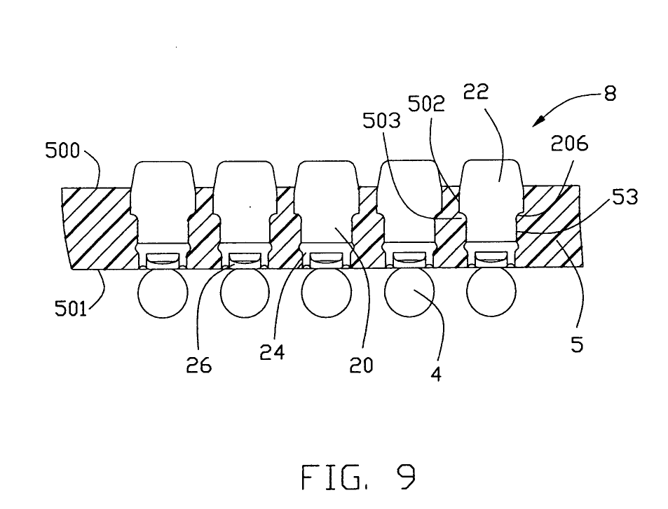

Referring to FIGS. 7 and 9, each plug contact 2 is substantially positioned in a central plane CP2 (FIG. 7) of the plug passageway 53 of the plug housing 5. The plug housing 5 defines a pair of retention slots 502 recessed outwardly from opposite inner faces of the plug passageway 53. Each retention slot 502 has a step 503. When the plug contact 2 is inserted into the passageway 53 of the plug housing 5 from the mating face 500, the step 503 is pressed deformatively and some of material of the step 503 is pressed into the recess 206 of the plug contact 2 to retain the plug contact 2 in the plug housing 5. The solder ball 4 extends downwardly beyond the mounting face 501 of the plug housing 5 for soldering to the second circuit substrate on which the plug connector 8 is mounted.

It is noted that although FIG. 8 shows that the solder ball 4 is fused to the mounting platform 26 before the plug contact 2 is assembled into the plug housing 5, the solder ball 4 can also be fused to the mounting platform 26 after the plug contact 2 is assembled to the housing 5.

The solder ball 4 has an outer diameter that closely corresponds to the width of the passageway 53 that receives the corresponding contact 2, thereby allowing the contact 2 and the solder ball 4 to be removed as a single structure when there is any damage to the contact 2 either during manufacture or during use/installation. Even if the solder ball 4 is slightly larger than the width of the passageway 53, since the solder ball 4 is formed from tin-lead, which is a relatively soft material, it will slightly deform to allow the contact 2 and the solder ball 4 to be removed together.

Referring to FIGS. 4 and 5, when the receptacle connector 6 and the plug connector 8 mate with each other, the pair of cantilevered arms 92 of the receptacle contact 9 engages with the mating portion 22 of the plug contact 2. At the same time, the pair of cantilevered arms 92 are received in the rectangular passageway 53 of the plug housing 5 and located at opposite sides of the plug contact 2.

Referring to FIG. 6 in conjunction with FIGS. 1 and 9, when the receptacle connector 6′ is to be mated with the plug connector 8, the mating portion 22 of the plug contact 2 is guided by the projections 74′ into the corresponding passageway 73′ in which the receptacle contact 9′ is received and to be sandwiched between the pair of cantilevered arms 92′ of the receptacle contact 9′.

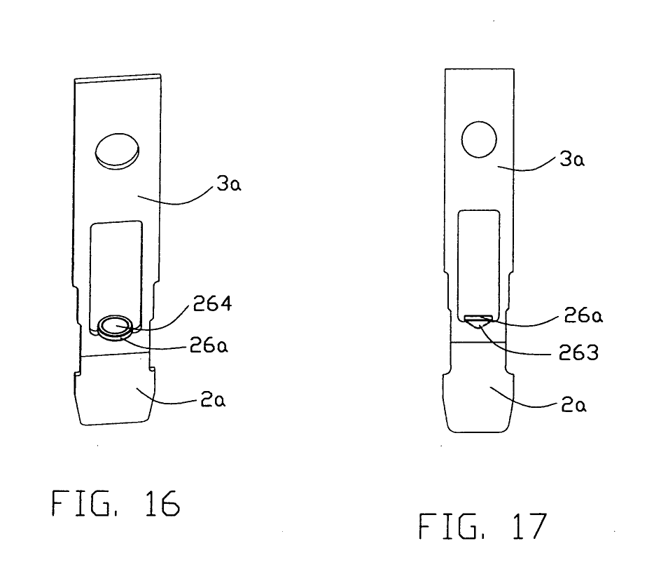

FIGS. 16 and 17 show the unit of the carrier strip comprising a plug contact 2a connecting with a carrier 3a in accordance with a second embodiment of the present invention. The plug contact 2a is substantially identical to the plug contact 2 except for a mounting platform 26a thereof. The mounting platform 26a is created from the projection 25 (shown in FIG. 10) by qualifying the projection 25 without any splitting. The mounting platform 26a defines a dimple 263 coined to provide a concave surface 264 for positioning the solder ball 4.

FIG. 18 illustrates a plug contact 2b in accordance with a third embodiment of the present invention. The plug contact 2b is substantially identical to the plug contact 2 except for a mating portion 22b thereof. The mating portion 22b includes a split lead-in portion 221 having a pair of laterally offset, symmetrical diverging beams 2210, 2212 which extend upwardly and are angled transversely outwardly of a final contact area 223 of the mating portion 22b. The diverging beams 2210, 2212 define inwardly opposing, laterally offset, symmetrical faces 2213, 2214. When the plug contact 2b is inserted into the receptacle contact 9, the diverging beams 2210, 2212 initially engage the contact portions 920 of the cantilevered arms 92. The diverging beams 2210, 2212 of the plug contact 2b are effective to gradually deflect the cantilevered arms 92 in opposite directions, causing the normal force between the plug contact 2b and receptacle contact 9 to gradually increase.

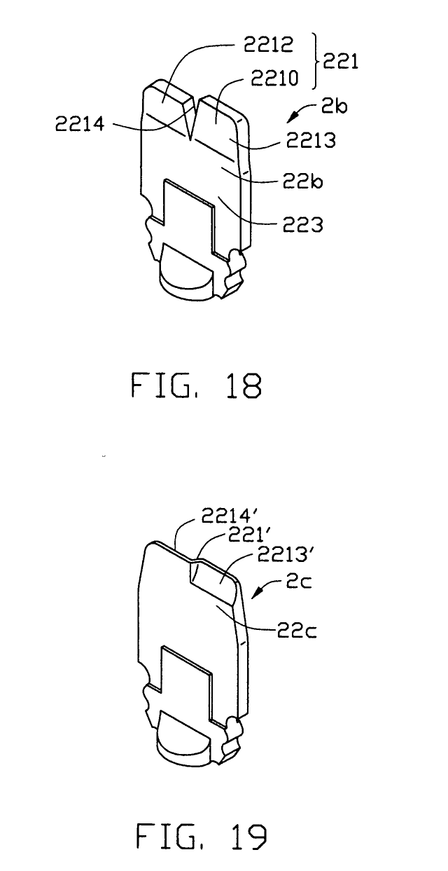

FIG. 19 illustrates a plug contact 2c in accordance with a fourth embodiment of the present invention. The plug contact 2c is substantially identical to the plug contact 2 except for a mating portion thereof 22c. The mating portion 22c includes a lead-in portion 221′ which is integral and defines a pair of inwardly opposing, laterally offset, symmetrical faces 2213′, 2214′.

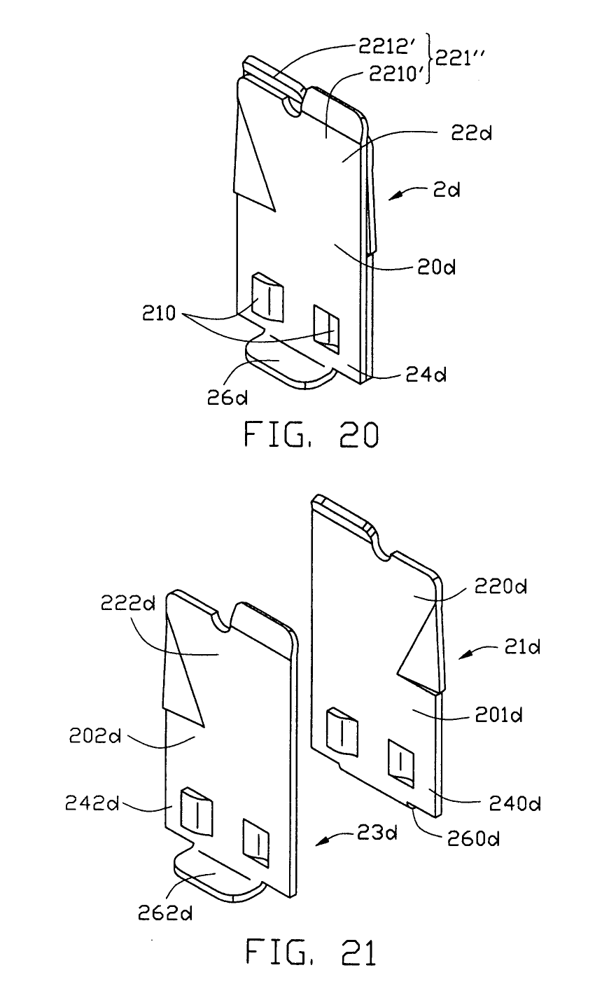

FIGS. 20 and 21 show a plug contact 2d in accordance with a fifth embodiment of the present invention. The plug contact 2d is a two-piece configuration and comprises two separate pieces: a first piece 21d and a second piece 23d. The first and the second pieces 21d, 23d are interconnected via a locking means 210, thereby forming the plug contact 2d. The plug contact 2d comprises an intermediate portion 20d, a mating portion 22d, a tail portion 24d and a mounting platform 26d adjacent a bottom edge of the tail portion 24d. The first piece 21d comprises a first intermediate portion 201d, a first mating portion 220d extending from the first intermediate portion 201d, a first tail portion 240d extending from the first intermediate portion 201d in a direction away from the first mating portion 220d and a first half mounting platform 260d bent from a free end of the first tail portion 240d. The second piece 23d comprises a second intermediate portion 202d, a second mating portion 222d extending from the second intermediate portion 202d, a second tail portion 242d extending from the second intermediate portion 202d in a direction away from the second mating portion 222d and a second half mounting platform 262d bent from a free end of the second tail portion 242d. The first and the second intermediate portions 201d, 202d are stacked with each other to form the intermediate portion 20d. The first and the second mating portions 220d, 222d are stacked with each other to form the mating portion 22d. The first and the second half mounting platforms 260d, 262d cooperate with each other to form the mounting platform 26d. It is noted that the mounting platform 26d is a split pedestal. The mating portion 22d includes a split lead-in portion 221″ having a pair of laterally offset, symmetrical diverging beams 2210′, 2212′. The diverging beams 2210′, 2212′ are respectively formed on the first and the second pieces 21d, 23d.

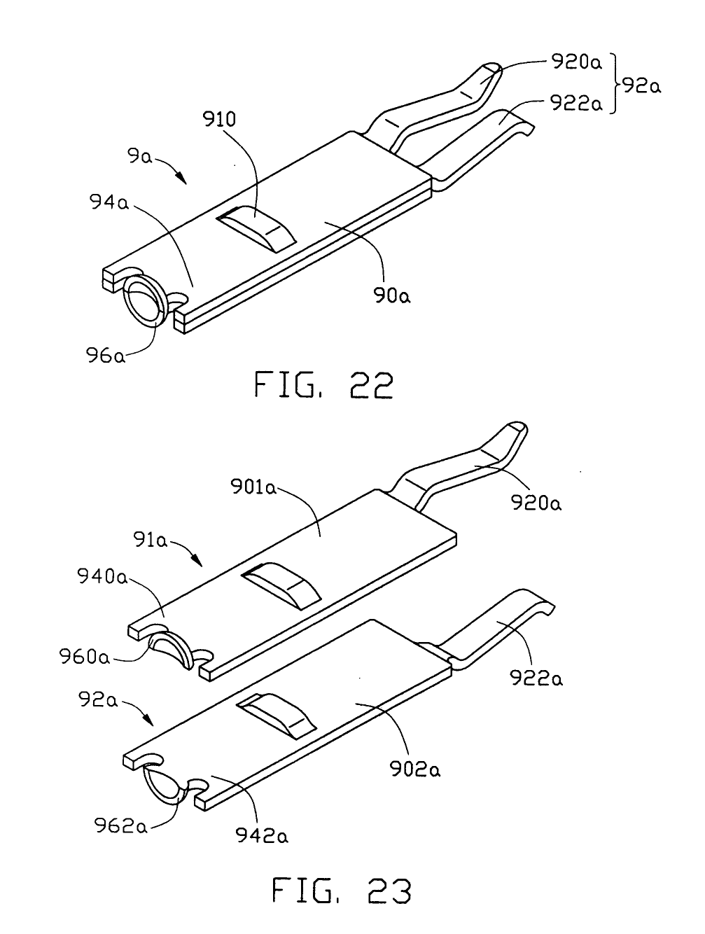

FIGS. 22 and 23 show a receptacle contact 9a in accordance with a second embodiment of the present invention. The receptacle contact 9a is a two-piece configuration and comprises two separate pieces: a first piece 91a and a second piece 92a. The first and the second pieces 91a, 92a are interconnected via a locking means 910, thereby forming the receptacle contact 9a. The receptacle contact 9a comprises an intermediate portion 90a, a mating portion 92a, a tail portion 94a, and a mounting platform 96a adjacent a bottom edge of the tail portion 94a. The first piece 91a comprises a first intermediate portion 901a, a first cantilevered arm 920a extending from the first intermediate portion 901a, a first tail portion 940a extending from the first intermediate portion 901a in a direction away from the first cantilevered arm 920a and a first half mounting platform 960a formed on the first tail portion 940a. The second piece 92a comprises a second intermediate portion 902a, a second cantilevered arm 922a extending from the second intermediate portion 902a, a second tail portion 942a extending from the second intermediate portion 902a in a direction away from the second cantilevered arm 922a and a second half mounting platform 962a formed on the second tail portion 942a. The first and the second intermediate portions 901a, 902a are stacked with each other to form the intermediate portion 90a. The first and the second cantilevered arms 920a, 922a together form the mating portion 92a. The first and the second half mounting platforms 960a, 962a cooperate with each other to form the mounting platform 96a. It is noted that the mounting platform 96a is also a split pedestal. Each of the first and the second half mounting platforms 960a, 962a are formed by substantially the same manner as the mounting platform 26a of the plug contact 2a described above.

Although the first piece and the second piece of the contact disclosed in the above embodiments are all interconnected by locking means, it should also be understandable that the first piece and the second piece can be received in a same passageway of the connector housing without utilizing of the locking means formed on the contact. For instance, one piece can be separately inserted and retained in a passageway by retention means formed on this piece and an inner wall of the passageway, and then the other piece is inserted into the passageway and retained therein. The two pieces contact with each other in the same passageway, but do not have any locking means formed therebetween.

It is appreciated that each of the plug contacts 2, 2a, 2b, 2c and 2d is positioned in the central plane CP2 of a corresponding plug passageway 53 of the plug housing 5. It is also appreciated that each of the receptacle contacts 9, 9a is positioned in the central plane CP1 of a corresponding receptacle passageway 73 of the receptacle housing 7. It is preferable that each of the mounting platforms of the plug contacts 2, 2a, 2b, 2c and 2d is substantially symmetrical with respect to the centerline of the thickness of the plug contacts 2, 2a, 2b, 2c and 2d. It is also preferable that each of the mounting platforms 96, 96a of the receptacle contacts 9, 9a is substantially symmetrical with respect to the centerline of the thickness of the receptacle contacts 9, 9a.

Even the platform is formed by splitting, it should be understood that it can be done also through other processes, such coining, compressing and displacing the contact material. On the other hand, as described above, the present invention provide a through-hole type passage for contact. As such, the contact can be readily removed even after the connector is mounted on a printed circuit board, specially when the contact is damaged. It can be readily appreciate this feature through the description and illustration of the drawings discussed above. It should be noted that none of the prior arts allow the removal of the contact after the connector is mounted onto the printed circuit. Right after the contact is removed from the passage, the passage provides an access to reach the solder ball, and ready to remove the solder ball after the later is heated and softened.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method of making an electrical contact configured to receive a body of solder, comprising the steps of:
stamping a sheet of metal to profile a carrier strip including a plurality of contacts each having a bottom edge; and
forming a mounting platform adjacent the bottom edge on each of the contacts, the mounting platform being configured to receive the body of solder.

2. The method as claimed in claim 1, wherein the step of stamping comprises forming a projection at the bottom edge of the contact which will be transformed into the mounting platform.

3. The method as claimed in claim 2, wherein the step of forming the mounting platform comprises splitting the projection.

4. The method as claimed in claim 2, further comprising a step of attaching a body of solder to the mounting platform before the contact is removed from the carrier strip.

5. The method as claimed in claim 4, further comprising a step of removing the contact from the carrier strip after the step of attaching.

6. The method as claimed in claim 4, wherein the step of forming the mounting platform comprises forming a dimple in the mounting platform to position the body of solder.

7. The method as claimed in claim 1; wherein the mounting platform comprises a first portion extending from the bottom edge in a direction substantially perpendicular to the contact, and a second portion extending from the bottom edge in a direction substantially perpendicular to the contact and extending away from the first portion.

8. The method as claimed in claim 1, wherein the mounting platform is substantially symmetric with respect to the centerline of the thickness of the contact.

9. A contact for an electrical connector comprising:
a stamped body portion defining a bottom edge; and
a mounting platform formed adjacent to the bottom edge of the body portion adapted to receive a body of solder, the mounting platform comprising a first portion extending substantially perpendicular to the body portion, and a second portion extending substantially perpendicular to the body portion and away from the first portion.

10. The contact as claimed in claim 9, wherein the body portion comprises a mating portion adapted for engaging with a mating contact.

11. The contact as claimed in claim 10, wherein the mating portion includes an upwardly extending lead-in portion defining a pair of inwardly opposing, laterally offset, symmetrical faces adapted to initially engage and gradually deflect cantilevered arms of the mating contact.

12. The contact as claimed in claim 11, wherein the lead-in portion includes a pair of laterally offset, symmetrical diverging beams, and wherein the pair of opposing, laterally offset, symmetrical faces is respectively defined in the diverging beams.

13. The contact as claimed in claim 12, wherein the contact comprises a first piece and a second piece, and wherein the pair of laterally offset, symmetrical diverging beams is respectively formed on the first and the second pieces.

14. The contact as claimed in claim 9, wherein the body portion includes shoulders along sides thereof.

15. The contact as claimed in claim 9, wherein the first portion is larger than the second portion.

16. The contact as claimed in claim 9, wherein the first and the second portions are symmetrically arranged with respect to the centerline of the thickness of the body portion.

17. The contact as claimed in claim 9, wherein the mounting platform is substantially symmetric with respect to its centerlines in two directions.

18. The contact as claimed in claim 9, wherein a centerline of the mounting platform is offset from the centerline of the width of the body portion along a width direction of the body portion.

19. The contact as claimed in claim 9, wherein the body portion has a rectangular shape.

20. The contact as claimed in claim 9, further comprising a pair of cantilevered arms extending upwardly from the body portion.

21. The contact as claimed in claim 20, wherein the contact comprises a first piece and a second piece, and wherein the first and the second portions of the mounting platforms are respectively formed on the first and the second pieces.

22. The contact as claimed in claim 21, wherein the pair of cantilevered arms are respectively formed on the first and the second pieces.

23. A carrier strip comprising:
a carrier; and
at least one stamped contact connected to the carrier and comprising:
an intermediate portion;
a mating portion extending from the intermediate portion adapted for engaging with a mating contact;
a tail portion connected between the intermediate portion and the carrier; and
a mounting platform formed adjacent to a bottom edge of the tail portion and extending beyond opposite surfaces of the tail portion.

24. The carrier strip as claimed in claim 23, further comprising a fusible element fused on the mounting platform.

25. The carrier strip as claimed in claim 24, wherein the carrier defines a slot extending adjacent to the mounting platform to accommodate the fusible element.

26. The carrier strip as claimed in claim 24, wherein the fusible element is a solder ball.

27. The carrier strip as claimed in claim 23, wherein the mating portion has a larger width than the intermediate portion.

28. The carrier strip as claimed in claim 23, wherein the mating portion has a thinner width than the intermediate portion.

29. An electrical connector comprising:
a dielectric housing defining a passageway defining a central plane;
a stamped contact comprising a body portion retained in the passageway and residing substantially in the central plane of the passageway, the contact comprising a bottom portion; and
a mounting platform formed at the bottom portion adapted to receive a mass of solder.

30. The electrical connector as claimed in claim 29, wherein the mounting platform is substantially symmetric with respect to the central plane of the passageway.

31. The electrical connector as claimed in claim 30, wherein the contact comprises a first piece and a second piece, and wherein each piece defines a half of the mounting platform.

32. The electrical connector as claimed in claim 31, wherein each contact comprises a pair of cantilevered arms opposite to the mounting platform, the pair of cantilevered arms being respectively formed on the first and the second pieces.

33. The electrical connector as claimed in claim 29, wherein the housing defines a retention slot recessed from an inner face of the passageway, the retention slot having a step, and wherein the body portion of the contact comprises a shoulder and a recess adjacent the shoulder, the shoulder and the recess engaging with the step.

34. The electrical connector as claimed in claim 29, wherein the solder pre-form is a solder ball, the solder ball having an outer diameter that closely corresponds to the width of the passageway.

35. The electrical connector as claimed in claim 34, wherein the solder ball is slightly larger than the width of the passageway.

36. The electrical connector as claimed in claim 29, wherein the solder pre-form is attached to the mounting platform before the contact is inserted into the passageway of the housing.

37. The electrical connector as claimed in claim 29, wherein the solder pre-form is attached to the mounting platform after the contact is inserted into the passageway of the housing.

38. The electrical connector as claimed in claim 29, wherein the mounting platform is located adjacent a mounting face of the housing, and wherein the solder pre-form is spaced from the mounting face of the housing.

39. An electrical connector comprising:
a dielectric housing defining a passageway extending from a mating face to a mounting face thereof;
a contact received in the passageway and comprising a body portion and a pair of cantilevered arms extending from the body portion, the cantilevered arms being completely exposed beyond the mating face of the housing; and
a mounting platform formed on the body portion opposite to the cantilevered arms adapted to receive a fusible element and located adjacent the mounting face of the housing.

40. The electrical connector as claimed in claim 39, wherein the contact is substantially positioned in a central plane of the passageway.

41. The electrical connector as claimed in claim 39, wherein the mounting platform comprises a first portion extending in a direction substantially perpendicular to the tail portion, and a second portion opposite to the first portion.

42. An electrical interconnection comprising:
a first connector, comprising:
a first dielectric housing defining a first passageway extending from a mating face to a mounting face thereof; and
a first stamped contact disposed in the first passageway and having a first mounting platform located substantially adjacent the mounting face of the first housing and adapted to receive a solder pre-form thereon; and
a second connector configured to mate with the first connector, the second connector comprising:
a second dielectric housing defining a second passageway extending from a mating face to a mounting face thereof; and
a second contact disposed in the second passageway, the second contact comprising at least one cantilevered arm for electrically engaging with the first contact during mating of the first connector with the second connector.

43. The electrical interconnection as claimed in claim 42, wherein at least one cantilevered arm is completely exposed beyond the mating face of the second housing.

44. The electrical interconnection as claimed in claim 42, wherein at least one cantilevered arm is completely received in the second passageway.

45. The electrical interconnection as claimed in claim 43, wherein the second housing is formed with a projection extending into the second passageway adjacent the mating face thereof, the projection defining a guiding face for guiding the insertion of the first contact.

46. The electrical interconnection as claimed in claim 44, wherein at least one cantilevered arm comprises a free end located below the projection.

47. The electrical interconnection as claimed in claim 42, wherein the second contact comprises a second mounting platform located substantially adjacent the mounting face of the second housing and adapted for receiving a mass of solder pre-form thereon.

48. The electrical interconnection as claimed in claim 42, wherein the second contact comprises two cantilevered arms received in the first passageway and located at opposite sides of the first contact received in the first passageway during mating of the first connector with the second connector.

49. The electrical interconnection as claimed in claim 48, wherein the first contact is disposed substantially in a central plane of the first passageway.

50. The electrical interconnection as claimed in claim 48, wherein the first contact includes an upwardly extending lead-in portion defining a pair of inwardly opposing, laterally offset, symmetrical faces to initially engage and gradually deflect the cantilevered arms of the second contact.

51. The electrical interconnection as claimed in claim 50, wherein the lead-in portion includes a pair of laterally offset, symmetrical diverging beams, and wherein the pair of opposing, laterally offset, symmetrical faces is respectively defined in the diverging beams.

52. An electrical connector comprising:
a housing defining a passageway;
a stamped contact positioned in the passageway and including a split pedestal; and
a solder pre-form disposed on the pedestal.

53. The electrical connector as claimed in claim 52, wherein the pedestal extends substantially below a bottom surface of the housing.

54. A stamped electrical contact adapted to be disposed in a passageway of a connector housing, comprising:
a body portion adapted to be positioned substantially along a central plane of the passageway of the connector housing;
a pair of cantilevered arms extending from the body portion; and
a tail portion extending from the body portion and having a split pedestal.

55. A contact adapted to be disposed in an electrical connector to be mated with a complementary connector, comprising:
a body portion stamped from a sheet of conductive material;
a retention portion formed along a longitudinal side of the body portion; and
a split pedestal formed on the bottom of the body portion adapted to receive a solder pre-form thereon.

56. An electrical connector comprising:
a housing defining a first and a second surface with a passageway extending therebetween;
a stamped contact positioned in the passageway and including a split pedestal; and
a solder pre-form disposed on the pedestal;
wherein the solder mass can be removed through the passageway after the contact is removed from passageway.

57. The electrical connector as claimed in claim 56, wherein the contact is inserted into the passageway from the first surface.

58. The electrical connector as claimed in claim 56, wherein the pedestal is located substantially around the second surface.
